(19) United States
(12) Patent Application Publication
(10) Pub. No.: US 2017/0257669 A1
(43) Pub. Date: Sep. 7, 2017

(54) Enhanced Content Viewing Experience Based on User Engagement

(71) Applicant: AT&T INTELLECTUAL PROPERTY I, L.P., ATLANTA, GA (US)

(72) Inventors: ZHU LIU, MARLBORO, NJ (US); LEE BEGEJA, GILLETTE, NJ (US); DAVID CRAWFORD GIBBON, LINCROFT, NJ (US); RAGHURAMAN GOPALAN, UNION CITY, CA (US); YADONG MU, MIDDLETON, NJ (US); BERNARD S. RENGER, NEW PROVIDENCE, NJ (US); BEHZAD SHAHRARAY, HOLMDEL, NJ (US); ERIC ZAVESKY, AUSTIN, TX (US)

(21) Appl. No.: 15/058,335

(22) Filed: Mar. 2, 2016

(51) Int. Cl. H04N 21/442; H04N 21/81; H04N 21/4223; H04N 21/4147; H04N 21/466; H04N 21/44; H04N 21/2668; H04N 21/8549; G06K 9/00; H04N 21/422

(52) U.S. Cl. CPC H04N 21/44218; G06K 9/00302; H04N 21/812; H04N 21/4223; H04N 21/42201; H04N 21/8133; H04N 21/4667; H04N 21/44008; H04N 21/2668; H04N 21/8549; H04N 21/4147

(57) ABSTRACT

A method includes determining a level of user engagement associated with content of a program displayed at a first display device and comparing the level of user engagement to a threshold. If the level of user engagement satisfies the threshold, the method includes generating an advertisement associated with the content displayed at the first display device and determining whether the user is within a distance of the first display device during a commercial break of the program. The method also includes displaying the advertisement at the first display device during the commercial break if the user is within the distance of the first display device and displaying the advertisement at a second display device during the commercial break if the user is not within the distance of the first display device. If the level of user engagement fails to satisfy the threshold, generation of the advertisement is bypassed.

### FIELD OF THE DISCLOSURE

The present disclosure is generally related to a content viewing experience.

### BACKGROUND

Content providers may use different metrics to determine whether content that is provided (e.g., broadcasted) to televisions is of interest to an audience. For example, programmers may determine whether a particular program is “popular” based on the ratings of the particular program. To illustrate, programmers may determine that the particular program is popular if an estimated number of people that tuned into the particular program during a live telecast of the particular program satisfies a threshold. If the estimated number of people tuned into the particular program during the live telecast of the particular program fails to satisfy the threshold, the programmers may determine that the particular program is not popular. As another example, advertisers may determine whether a particular product that is advertised on a television channel is “of interest” to the viewers of the television channel based on product sales. To illustrate, an advertiser may use commercials to advertise the particular product on the television channel. If the product sales of the particular product increase, the advertiser may determine that viewers of the television channel are interested in the particular product. If the product sales of the particular product decrease or remain substantially similar, the advertiser may determine that viewers of the television channel are not interested in the particular product.

Although content providers (and advertisers) may use different metrics to determine whether content (and products) displayed is of interest to a broad audience, it may be difficult to determine whether the content (and products) is of interest to a particular viewer. For example, content providers may not know whether the particular viewer is “enjoying” or “interested in” the content as the content is displayed at a television of the particular viewer.

### BRIEF DESCRIPTION OF THE DRAWINGS

FIG. 1 illustrates a system for enhancing a viewing experience based on user engagement.

FIG. 2 illustrates a method for enhancing a viewing experience based on user engagement.

FIG. 3 illustrates features provided to a user based on user engagement to enhance a viewing experience.

FIG. 4 illustrates another system for enhancing a viewing experience based on user engagement.

FIG. 5 illustrates another method for enhancing a viewing experience based on user engagement.

FIG. 6 illustrates an example environment for the techniques described with respect to FIGS. 1-5.

FIG. 7 is a schematic block diagram of a sample-computing environment for the techniques described with respect to FIGS. 1-5.

### DETAILED DESCRIPTION

According to the techniques described herein, a method includes determining, at a processor, a level of user engagement associated with content of a particular program displayed at a first display device. The method also includes comparing the level of user engagement to a threshold. If the level of user engagement satisfies the threshold, the method includes generating an advertisement associated with the content and determining whether a user is within a particular distance of the first display device during a first interval. The method also includes displaying the advertisement at the first display device during the first interval if the user is within the particular distance of the first display device and displaying the advertisement at a second display device during the first interval if the user is not within the particular distance of the first display device. If the level of user engagement fails to satisfy the threshold, the method includes bypassing generation of the advertisement.

According to the techniques described herein, an apparatus includes a processor and a memory storing instructions that are executable by the processor to perform operations including determining a level of user engagement associated with content of a particular program displayed at a first display device. The operations also include comparing the level of user engagement to a threshold. If the level of user engagement satisfies the threshold, the operations include generating an advertisement associated with the content and determining whether a user is within a particular distance of the first display device during a first interval. The operations also include displaying the advertisement at the first display device during the first interval if the user is within the particular distance of the first display device and displaying the advertisement at a second display device during the first interval if the user is not within the particular distance of the first display device. If the level of user engagement fails to satisfy the threshold, the operations include bypassing generation of the advertisement.

According to the techniques described herein, a computer-readable storage device includes instructions that, when executed by a processor, cause the processor to perform operations including determining a level of user engagement associated with content of a particular program displayed at a first display device. The operations also include comparing the level of user engagement to a threshold. If the level of user engagement satisfies the threshold, the operations include generating an advertisement associated with the content and determining whether a user is within a particular distance of the first display device during a first interval. The operations also include displaying the advertisement at the first display device during the first interval if the user is within the particular distance of the first display device and displaying the advertisement at a second display device during the first interval if the user is not within the particular distance of the first display device. If the level of user engagement fails to satisfy the threshold, the operations include bypassing generation of the advertisement.

According to the techniques described herein, a method includes determining, at a processor, a level of user engagement associated with live content of a particular program displayed at a first display device. The method also includes determining a period of time that a user is not within a particular distance of the first display device in response to determining that the level of user engagement satisfies a first threshold. The method further includes displaying a summary of the live content at the first display device if the period of time satisfies a second threshold. The summary summarizes portions of the live content broadcasted while the user was not within the particular distance of the first display device. The method also includes displaying stored content at the first display device if the period of time fails to satisfy the second threshold. The stored content corresponds to portions of the live content broadcasted while the user was not within the particular distance of the first display device.

According to the techniques described herein, an apparatus includes a processor and a memory storing instructions that are executable by the processor to perform operations including determining a level of user engagement associated with live content of a particular program displayed at a first display device. The operations also include determining a period of time that a user is not within a particular distance of the first display device in response to determining that the level of user engagement satisfies a first threshold. The operations further include displaying a summary of the live content at the first display device if the period of time satisfies a second threshold. The summary summarizes portions of the live content broadcasted while the user was not within the particular distance of the first display device. The operations also include displaying stored content at the first display device if the period of time fails to satisfy the second threshold. The stored content corresponds to portions of the live content broadcasted while the user was not within the particular distance of the first display device.

According to the techniques described herein, a computer-readable storage device includes instructions that, when executed by a processor, cause the processor to perform operations including determining a level of user engagement associated with live content of a particular program displayed at a first display device. The operations also include determining a period of time that a user is not within a particular distance of the first display device in response to determining that the level of user engagement satisfies a first threshold. The operations further include displaying a summary of the live content at the first display device if the period of time satisfies a second threshold. The summary summarizes portions of the live content broadcasted while the user was not within the particular distance of the first display device. The operations also include displaying stored content at the first display device if the period of time fails to satisfy the second threshold. The stored content corresponds to portions of the live content broadcasted while the user was not within the particular distance of the first display device.

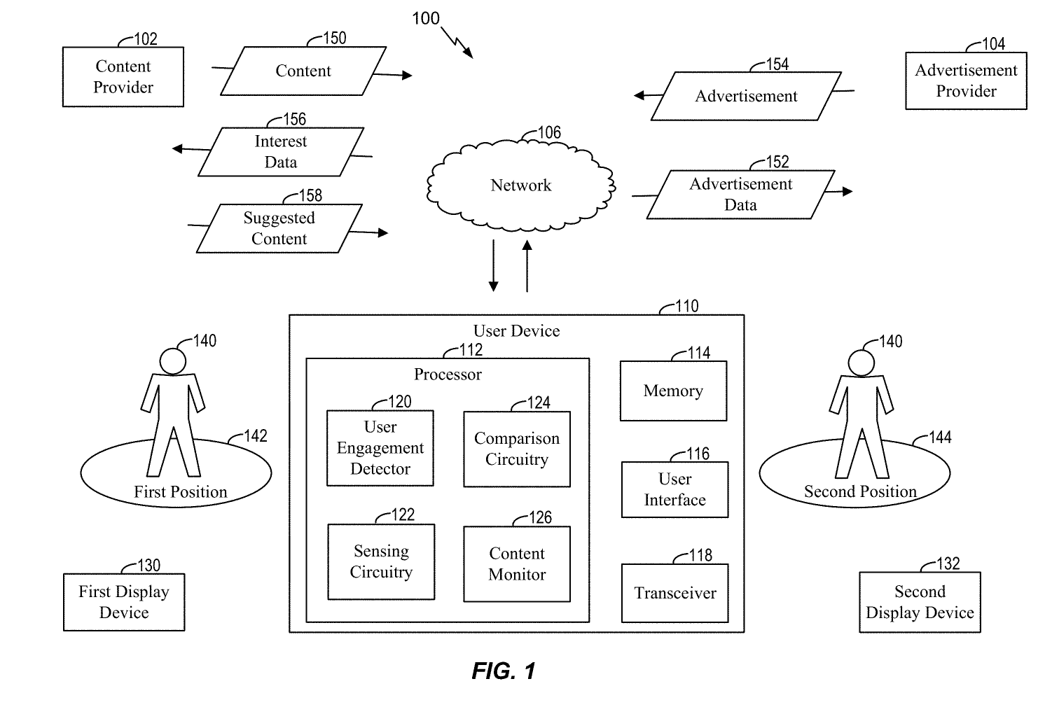

FIG. 1 illustrates a system 100 for enhancing a viewing experience based on user engagement. The system includes a content provider 102, an advertisement provider 104, a network 106, a user device 110, a first display device 130, and a second display device 132. According to one implementation, the first display device 130 (or the second display device 132) may include a television, a mobile phone, a tablet, a computer, etc. According to one implementation, operations performed by the content provider 102 and operations performed by the advertisement provider 104 may be performed using a single provider service (or a single server). As a non-limiting example, the content provider 102 and the advertisement provider 104 may be a single content provider service. The content provider 102 and the advertisement provider 104 may communicate with the user device 110 via the network 106. The network 106 may include any network that is operable to provide video from a source device to a destination device. As non-limiting example, the network 106 may include a mobile network, an Institute of Electrical and Electronics Engineers (IEEE) 802.11 network, a broadband network, a fiber optic network, a wireless wide area network (WWAN), etc.

The content provider 102 may be configured to provide content 150 to the user device 110 via the network 106. According to one implementation, the content 150 may be included in a program (e.g., a television program). For example, the content provider 102 may transmit the program to a plurality of user devices (e.g., set-top boxes, mobile devices, computers, etc.), and each user device may display the program on a user-end device. To illustrate, the content provider 102 may provide the content 150 to the user device 110 via the network 106, and the user device 110 may display the content 150 at the first display device 130, the second display device 132, or both.

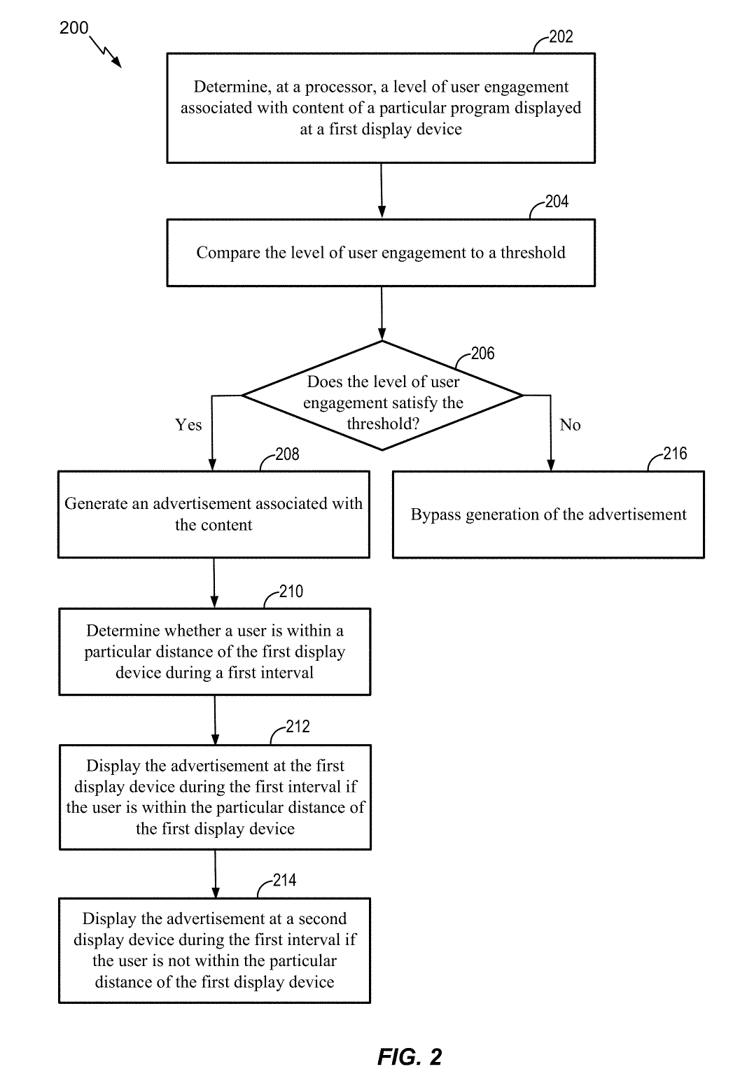

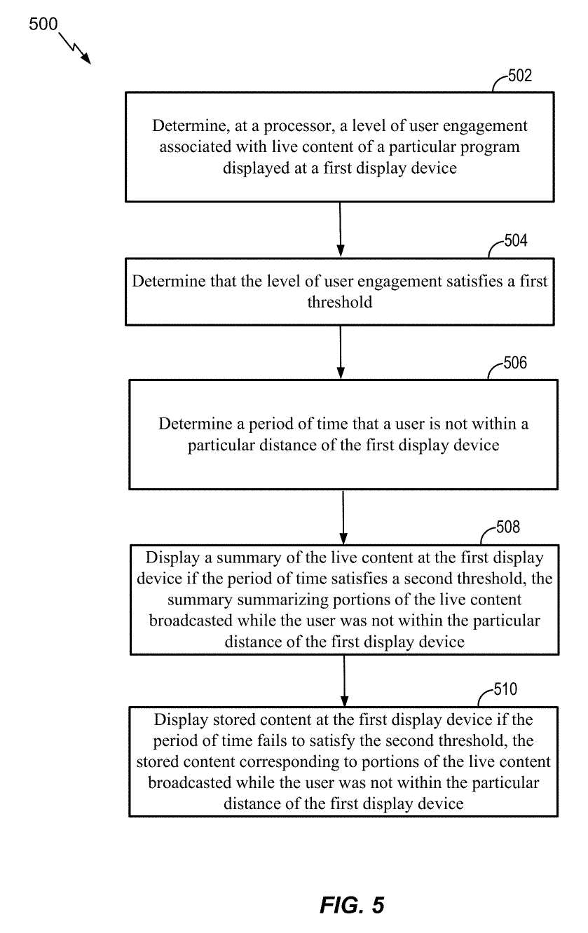

The user device 110 may be a media device located at a residence of a user. Non-limiting examples of the user device 110 may include a set-top box, a mobile device, a computer, etc. The user device 110 includes a processor 112, a memory 114, a user interface 116, and a transceiver 118. Although the user device 110 is shown to include four components, in other implementations, the user device 110 may include additional (or fewer components). The memory 114 may include a computer-readable storage device that includes instructions that, when executed by a processor 112, cause the processor 112 to perform operations, such as the operations described with respect to the method 200 of FIG. 2 and the method 500 of FIG. 5.

The processor 112 includes a user engagement detector 120, sensing circuitry 122, comparison circuitry 124, and a content monitor 126. As described below, the processor 112 may be configured to enhance a viewing experience of the user 140 based on user engagement. To illustrate, the processor 112 may determine whether the user 140 is engaged with the content 150. Upon determining that the user 140 is engaged with the content 150, the processor 112 may generate an advertisement related to the content 150 and provide the advertisement to one of the display devices 130, 132.

To illustrate, the user 140 may be located at a first position 142 and may watch the content 150 displayed at the first display device 130. The first position 142 may be relatively close to (e.g., in the vicinity of) the first display device 130. The sensing circuitry 122 may include one or more cameras (e.g., depth cameras, infrared (IR) cameras, etc.) that are configured to detect or capture a facial expression of the user 140 while the content 150 is displayed at the first display device 130. It should be understood that detecting the user's 140 facial expression is merely one non-limiting example of detecting the user's enjoyment or level of engagement. Upon detecting the facial expression of the user 140 using the sensing circuitry 122, the user engagement detector 120 may be configured to determine a level of user engagement associated with the content 150 displayed at the first display device 130. Additionally, or in the alternative, the sensing circuitry 122 may include one or more accelerometers that are configured to measure sensory information of the user that is associated with the user's engagement. Other techniques, such as detecting a level of excitement in the user's 140 voice, may be used to detect the user's 140 enjoyment or level of engagement. These techniques may be performed using sensors, processors, and other devices. Additionally, the level of engagement may be determined by monitoring a pulse of the user 140, a temperature change of the user 140 (e.g., indicating whether the user 140 is “blushing”), the hair positioning of the user 140, or other biometric features.

For example, the user engagement detector 120 may include facial detection circuitry to detect whether the user 140 is smiling, frowning, crying, laughing, etc., while the content 150 is displayed at the first display device 130. Upon detecting an expression of the user 140, the user engagement detector 120 may determine an intensity level of the expression. As a non-limiting example, the user engagement detector 120 may determine that the user 140 is smiling while the content 150 is displayed at the first display device 130. In response to determining that the user 140 is smiling, the user engagement detector 120 may generate (or assign) a numerical indicator that is representative of the “intensity level” of the user's 140 smile. The intensity level of the smile may be indicative of the level of user engagement. To illustrate, the intensity level may be a numerical value between zero and ten. If the user engagement detector 120 determines that the user 140 has a “small” smile, the user engagement detector 120 may assign a low intensity level (e.g., an intensity level of zero, one, two, or three) to represent the user's 140 smile. If the user engagement detector 120 determines that the user 140 has a “big” smile, the user engagement detector 120 may assign a high intensity level (e.g., an intensity level of seven, eight, nine, or ten) to represent the user's 140 smile. According to some implementations, the user engagement detector 120 may include a microphone and an audio classifier to determine whether the user 140 is engaged. For example, the microphone may capture laughter and the audio classifier may classify the laughter as a form of enjoyment.

The processor 112 may set different thresholds for different emotions. As non-limiting examples, the processor 112 may set a smiling threshold at eight, a frowning threshold at seven, a crying threshold at six, a laughing threshold at eight, etc. In other implementations, each emotion may be associated with a similar threshold. As a non-limiting example, the smiling threshold, the frowning threshold, the crying threshold, and the laughing threshold may each be set to eight. The comparison circuitry 124 may be configured to compare the level of user engagement to a threshold. Using the above example (e.g., where the user engagement detector 120 determines that the user is smiling), the comparison circuitry 124 may compare the intensity level of the user's 140 smile to a smiling threshold. If the intensity level of the user's 140 smile is equal to or greater than the smiling threshold, the comparison circuitry 124 may determine that the level of user engagement satisfies threshold. If the intensity level of the user's 140 smile is less than the smiling threshold, the comparison circuitry 124 may determine that the level of user engagement fails to satisfy the threshold. According to one implementation, the processor 112 may apply an indicator of the user's 140 enjoyment to a recording of the content 150. For example, if the user 140 is smiling during playback of the content 150, the processor 112 may apply an indicator to a recording of the content 150 to indicate that the user 140 enjoys the content 150. According to one implementation, the indicator may include data (e.g., metadata) that is stored with recording of the content 150. According to another example, the indicator may be a visual indicator, such as a “smiley face” or a “smiley emoji”, that overlays the recording of the content 150 during playback of the recording at a display device.

If the comparison circuitry 124 determines that the level of user engagement satisfies the threshold, the processor 112 may generate advertisement data 152 associated with the content 150 displayed at the first display device 130. To illustrate, the content monitor 126 may be configured to monitor the content 150 as the content 150 is displayed at the first display device 130. For example, the content monitor 126 may monitor the subject matter of the content 150 displayed at the first display device 130 when the level of user engagement satisfies the threshold. The processor 112 may be configured to generate advertisement data 152 (e.g., metadata) based on the subject matter of the content 150 in response to a determination the level of user engagement satisfies the threshold. For example, if the subject matter of the content 150 is associated with a particular clothing store, the advertisement data 152 may indicate that the particular clothing store is of interest to the user 140. As another example, if the subject matter of the content 150 is associated with a particular restaurant, the advertisement data 152 may indicate that the particular restaurant is of interest to the user 140.

After generating the advertisement data 152 at the processor 112, the transceiver 118 may send the advertisement data 152 to the advertisement provider 104 via the network 106. Upon receiving the advertisement data 152, the advertisement provider 104 may send the advertisement 154 to the user device 110 via the network 106. Alternatively, the memory 114 may store a plurality of advertisements, and upon generating the advertisement data 152 at the processor 112, the processor 112 may retrieve the advertisement 154 from the memory 114.

After retrieving the advertisement 154 (from the advertisement provider 104 or the memory 114), the processor 112 may determine whether the user 140 is within a particular distance of the first display device 130 during a particular interval (e.g., during a commercial break in the program associated the content 150). For example, the sensing circuitry 122 may include positioning sensors to determine whether the user 140 is physically located closer to the first display device 130 (e.g., whether the user 140 is at the first position 142) during the commercial break or physically located closer to the second display device 132 (e.g., whether the user 140 is at the second position 144) during the particular interval. If the user 140 is within the particular distance of the first display device 130 during the particular interval (e.g., if the user 140 is at the first position 142), the processor 112 may display the advertisement 154 at the first display device 130 during the particular interval. If the user 140 is not within the particular distance of the first display device 130 during the particular interval (e.g., if the user 140 is at the second position 144), the processor 112 may display the advertisement 154 at the second display device 132 during the particular interval.

If the comparison circuitry 124 determines that the level of user engagement fails to satisfy the threshold, the processor 112 may bypass generation of the advertisement 154. For example, if the processor 112 determines that the user 140 is not engaged with the content 150 presented at the first display device 130, user-targeted advertisements specific to the user 140 (e.g., the advertisement 154) may be bypassed during the particular interval. If the user-targeted advertisements are bypassed, default advertisements (e.g., advertisements embedded in or received with the content 150) may be displayed during the particular interval.

According to another implementation, the processor 112 may generate interest data 156 that indicates whether the content 150 displayed at the first display device 130 is “of interest” to the user 140. For example, using the techniques described above to determine the level of user engagement, the processor 112 may generate the interest data 156 to indicate whether the user 140 is interested in the content 150 currently displayed at the first display device 130. The transceiver 118 may send the interest data 156 to the content provider 102 via the network 106, and the content provider 102 may send suggested content 158 to the user device 110 based on the interest data 156. For example, if the interest data 156 indicates that the content 150 is of interest to the user 140, the suggested content 158 may identify similar programs offered by the content provider 102. If the interest data 156 indicates that the content 150 is not of interest to the user 140, the suggested content 158 may identify programs having substantially different content that is offered by the content provider 102.

According to one implementation, the processor 112 may control programming on the first display device 130 and the second display device 132 based on the level of user engagement and based on the location of the user 140. For example, if processor 112 determines that the user 140 is engaged in the content displayed at the first display device 130 while the user is located at the first positon 142 (e.g., in a first room), the processor 112 may display the content 150 at the second display device 132 (in a second room) in response to a determination that the user 140 has moved to the second position 144.

According to one implementation, the first display device 130 may be a television and the second display device 132 may be a mobile device of the user 140. According to this implementation, the processor 112 may determine whether the user 140 is looking at the first display device 130 or the second display device 132 during the particular interval. For example, the sensing circuitry 122 may include cameras that are configured to sense a viewing direction of the user's 140 eyes. If the processor 112 determines that the user 140 is looking at the first display device 130, the processor 112 may display the advertisement 154 at the first display device 130 during the particular interval. If the processor 112 determines that the user 140 is looking at the second display device 132, the processor 112 may display the advertisement 154 at the second display device 132 during the particular interval. Thus, in this implementation, the display device 130, 132 at which the advertisement 154 is displayed may be based on the where the user's “attention” is (as opposed to a location of the user 140).

If the processor 112 determines that the user 140 is engaged with his/her mobile device and is not engaged with the first display device 130, the user device 110 may send a signal to the content provider 102 that indicates that the user 140 is not interested in the content 150. According to one implementation, the processor 112 may generate advertisement data 152 associated with the content 150 that the user 140 is viewing on his/her mobile device, and an advertisement associated with the content may be displayed at the first display device 130.

According to some implementations, the advertisement 154 may be replayed upon a determination that the user 140 is looking away from the display devices 130, 132 when the advertisement 154 is initially displayed.

The system 100 of FIG. 1 may enable advertisers to generate advertisements that are of interest to the user 140 based on the user's 140 engagement with content 150 displayed at the first display device 130. Thus, instead of predicting whether the user 140 will be interested in a particular advertisement based on broad demographics associated with predicted viewers of a channel, advertisers may determine whether the user 140 will be interested in the particular advertisement based on the user's 140 engagement. Using the targeted advertisement techniques described with respect to FIG. 1 may reduce advertisement cost (and improve advertisement efficiency) by reducing the number of advertisements that are provided to “uninterested” viewers.

FIG. 2 illustrates a method 200 for enhancing a viewing experience based on user engagement. The method 200 may be performed by the user device 110 of FIG. 1.

The method 200 includes determining, at a processor, a level of user engagement associated with content of a particular program displayed at a first display device, at 202. For example, referring to FIG. 1, the sensing circuitry 122 may detect a facial expression of the user 140 while the content 150 is displayed at the first display device 130. Upon detecting the facial expression of the user 140 using the sensing circuitry 122, the user engagement detector 120 may determine the level of user engagement associated with the content 150 displayed at the first display device 130. For example, the user engagement detector 120 may include facial detection circuitry to detect the expression of the user 140, and the user engagement detector 120 may determine the intensity level of the expression. As a non-limiting example, the user engagement detector 120 may determine that the user 140 is laughing while the content 150 is displayed at the first display device 130. In response to the determining that the user 140 is laughing, the user engagement detector 120 may assign a numerical indicator representative of the “intensity level” of the user's 140 laugh. The intensity level of the laugh may be indicative of the level of user engagement. To illustrate, the intensity level may be a numerical value between zero and ten. If the user engagement detector 120 determines that the user 140 has a “small” laugh, the user engagement detector 120 may assign a low intensity level (e.g., an intensity level of zero, one, two, or three) to represent the user's 140 laugh. If the user engagement detector 120 determines that the user 140 has a “big” laugh, the user engagement detector 120 may assign a high intensity level (e.g., an intensity level of seven, eight, nine, or ten) to represent the user's 140 laugh.

The method 200 also includes comparing the level of user engagement to a threshold, at 204. As a non-limiting example, referring to FIG. 1, the processor 112 may set the laughing threshold to eight (on a scale from zero to ten). The comparison circuitry 124 may compare the level of user engagement to the laughing threshold. For example, the comparison circuitry 124 may compare the intensity level of the user's 140 laugh to the laughing threshold. If the intensity level of the user's 140 laugh is equal to or greater than the laughing threshold, the comparison circuitry 124 may determine that the level of user engagement satisfies the threshold. If the intensity level of the user's 140 laugh is less than the laughing threshold, the comparison circuitry 124 may determine that the level of user engagement fails to satisfy the threshold.

At 206, the method 200 includes determining whether the level of user engagement satisfies the threshold. If the level of user engagement satisfies the threshold, the method 200 includes generating an advertisement associated with the content, at 208. For example, referring to FIG. 1, if the comparison circuitry 124 determines that the level of user engagement satisfies the threshold, the processor 112 may generate the advertisement data 152 associated with the content 150 displayed at the first display device 130. To illustrate, the content monitor 126 may monitor the content 150 as the content 150 is displayed at the first display device 130. For example, the content monitor 126 may monitor the subject matter of the content 150 displayed at the first display device 130 when the level of user engagement satisfies the threshold. The processor 112 may generate the advertisement data 152 based on the subject matter of the content 150 in response to a determination the level of user engagement satisfies the threshold. After generating the advertisement data 152 at the processor 112, the transceiver 118 may send the advertisement data 152 to the advertisement provider 104 via the network 106. Upon receiving the advertisement data 152, the advertisement provider 104 may send the advertisement 154 to the user device 110 via the network 106. Alternatively, the memory 114 may store a plurality of advertisements, and upon generating the advertisement data 152 at the processor 112, the processor 112 may retrieve the advertisement 154 from the memory 114. Thus, as used herein, “generating” an advertisement at the user device 110 includes generating the advertisement data 152 and receiving the advertisement 154 (from the advertisement provider 104 or the memory 114) based on the advertisement data 152.

The method 200 also includes determining whether a user is within a particular distance of the first display device during a first interval, at 210. According to one implementation, the first interval may include a commercial break of the particular program. For example, referring to FIG. 1, the processor 112 may determine whether the user 140 is within a particular distance of the first display device 130 during a commercial break of the program associated the content 150.

The method 200 may also include displaying the advertisement at the first display device during the first interval if the user is within the particular distance of the first display device, at 212. For example, referring to FIG. 2, if the user 140 is within the particular distance of the first display device 130 during the commercial break (e.g., if the user 140 is at the first position 142), the processor 112 may display the advertisement 154 at the first display device 130 during the commercial break. The method 200 may also include displaying the advertisement at a second display device during the first interval if the user is not within the particular distance of the first display device, at 214. For example, referring to FIG. 2, if the user 140 is not within the particular distance of the first display device 130 during the commercial break (e.g., if the user 140 is at the second position 144), the processor 112 may display the advertisement 154 at the second display device 132 during the commercial break. According to one implementation, the content may be provided to a remote device (e.g., a set-top box or a digital video recorder) if the level of user engagement satisfies a threshold.

If the level of user engagement fails to satisfy the threshold, the method 200 includes bypassing generation of the advertisement, at 216. For example, referring to FIG. 1, if the comparison circuitry 124 determines that the level of user engagement fails to satisfy the threshold, the processor 112 may bypass generation of the advertisement 154. To illustrate, if the processor 112 determines that the user 140 is not engaged with the content 150 presented at the first display device 130, user-targeted advertisements specific to the user 140 may be bypassed during the commercial break of the program associated with the content 150. Instead, default advertisements (e.g., advertisements embedded in or received with the content 150) may be displayed during the commercial break (or during the designated interval). According to one implementation, the method 200 may also include changing the content if the level of user engagement fails to satisfy the threshold. For example, a channel associated with the particular program may be changed if the level of user engagement fails to satisfy the threshold.

The method 200 of FIG. 2 may enable advertisers to generate advertisements that are of interest to the user 140 based on the user's 140 engagement with content 150 displayed at the first display device 130. Thus, instead of predicting whether the user 140 will be interested in a particular advertisement based on broad demographics associated with predicted viewers of a channel, advertisers may determine whether the user 140 will be interested in the particular advertisement based on the user's 140 engagement. Using the targeted advertisement techniques described with respect to FIG. 2 may reduce advertisement cost (and improve advertisement efficiency) by reducing the number of advertisements that are provided to “uninterested” viewers.

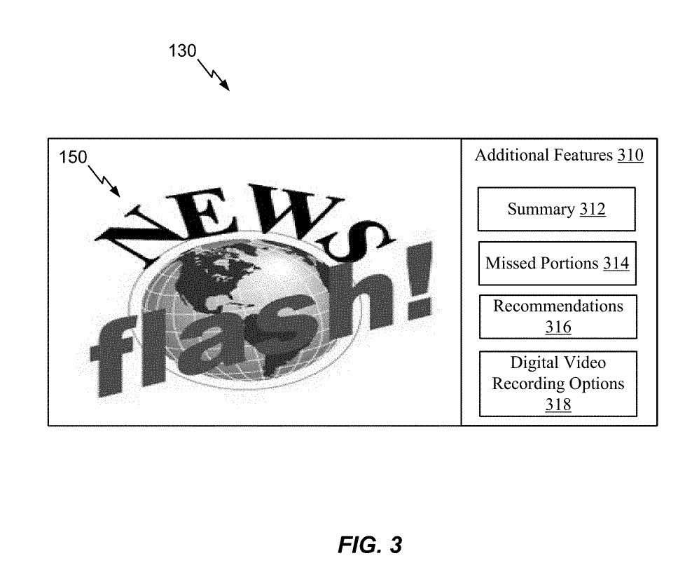

FIG. 3 illustrates features provided to a user based on user engagement to enhance a content viewing experience. For example, FIG. 3 illustrates the first display device 130 displaying the content 150 and additional features 310. The content 150 includes a “news flash” of a particular event. It should be understood that the content 150 shown in FIG. 3 is for illustrative purposes only and is not be construed as limiting. If the processor 112 determines that the level of user engagement satisfies the threshold, the processor 112 may provide the additional features 310 to the user 140 to enhance the content viewing experience.

For example, the additional features 310 may include a summary 312 of the content 150, missed portions 314 of the content 150, recommendations 316 of similar content, and digital video recording options 318. Each feature 310 may be selected by the user 140 using the user interface 116 of the user device 110. The summary 312 of the content 150 includes a text description of the content 150, a video clip highlighting portions of the content 150, etc. According to some implementations, the summary 312 may be a visual summary or a summary derived from video. The summary 312 may also include a textual description (e.g., closed caption). The summary 312 may also be provided as an overlay of an advertisement. According to one implementation, educational content may be summarized. For example, the summary 312 may summarize educational content using a textual description. If the educational content includes a lecturer, an option to provide feedback to the lecturer may be available through the user interface 116. According to one implementation, the summary 312 may be created by another user (not shown) viewing the content 150. For example, the other user may create the summary using speech, text, visual feedback, etc. The other user may provide the summary 312 via the network 106 or via a social media outlet. According to one implementation, a format of the summary 312 may be “fixed” based on a user's preference. According to another implementation, the summary 312 may be interactive. For example, the user 140 may select information in the summary 312 using the user interface 116 and additional information may be presented to the user 140. To illustrate, if an actor's name is presented in the summary 312, the user 140 may select the actor's name and a biography about the actor may be presented to the user 140.

If the processor 112 determines that the user 140 has left the vicinity of the first display device 130 (e.g., left the first position 142), a digital video recorder (not shown) may record the content 150 while the user 140 is away from the first display device. Upon returning to the vicinity of the first display device 130, the user 140 may select the missed portions 314 feature to play the recorded portions of the content 150 (e.g., the portions of the content 150 that the user 140 missed while away from the first display device 130).

If the user 140 selects the feature associated with recommendations 316 of similar content, the suggested content 158 from the content provider 102 may be displayed at the first display device 130. The suggested content 150 may identify similar programs offered by the content provider 102. The digital video recording options 318 may enable the user 140 to pause, rewind, fast-forward, or playback the content 150.

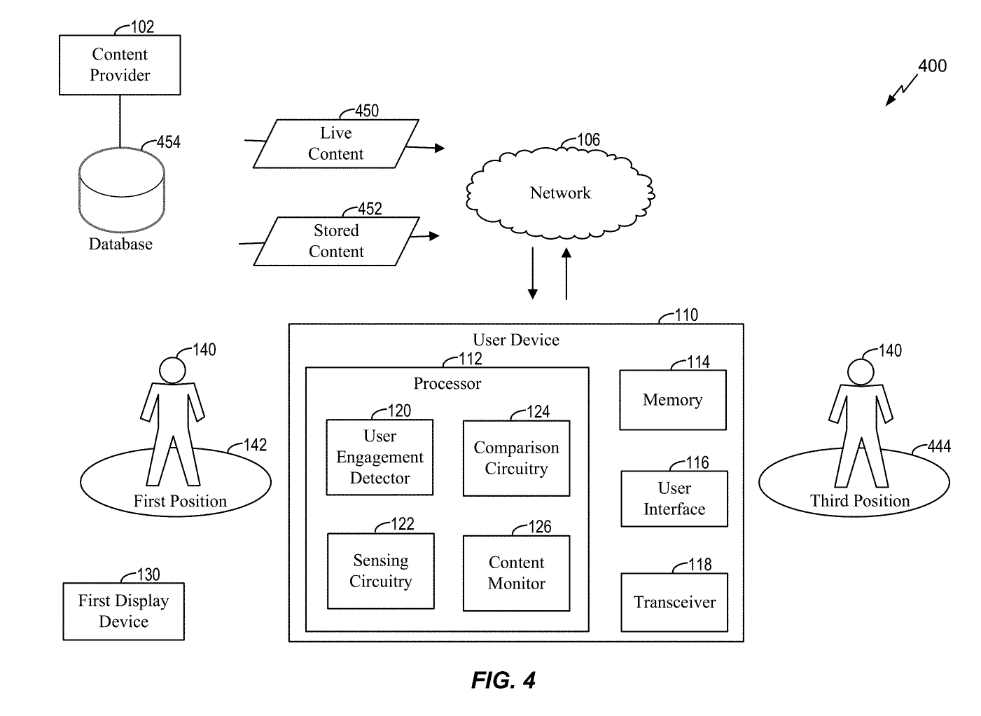

FIG. 4 illustrates another system 400 for enhancing a viewing experience based on user engagement. The system includes the content provider 102, the network 106, the user device 110, and the first display device 130.

The content provider 102 may be configured to provide live content 450 to the user device 110 via the network 106. According to one implementation, the live content 450 may be included in a program (e.g., a live television program). Non-limiting examples of the live television program may include a news program, a sports program, an award show, etc. The content provider 102 may provide the live content 450 to the user device 110 via the network 106, and the user device 110 may display the live content 450 at the first display device 130.

As described with respect to FIG. 1, the processor 112 may determine whether the level of user engagement satisfies the threshold (e.g., whether the user 140 is “interested in” the live content 450 displayed at the first display device 130). Upon a determination that the level of user engagement satisfies the threshold, the processor 112 may implement a process for “catching up” the user 140 on missed content if the user 140 leaves the vicinity of the first display device 130 (e.g., if the user 140 leaves the first position 142 and goes to a third position 444 that exceeds a threshold distance from the first display device 130).

To illustrate, the sensing circuitry 122 may determine whether the user 140 is physically located near the first display device 130 (e.g., whether the user 140 is at the first position 142 that fails to exceed the threshold distance from the first display device 130). As long as the user 140 is near the first display device 130, the live content 450 may be displayed at the first display device 130. However, if the user 140 leaves the vicinity of the first display device 130 (e.g., the user 140 goes to the third position 444), the processor 112 may determine the length of time that the user 140 is away from the first display device. If the length of time fails to satisfy (e.g., is less than) a threshold, the processor 112 may retrieve stored content 452 from the content provider 102 (or from the memory 114) and play the stored content 452 at the first display device 130 to “catch up” the user 140 with the content that the user 140 missed while the user 140 was away from the first display device 130. As a non-limiting example, the threshold may be five minutes. If the processor 112 determines that the user 140 is away from the first display device 130 for three minutes and then returns to the first display device 130, the processor 112 may generate a request for three minutes of stored content 452, and the transceiver 118 may send the request to the content provider 102 via the network 106. To illustrate, the content provider 102 may store the live content 450 in a database as stored content 452. Upon request from the user device 110, the content provider 102 may provide the stored content 452 to user device 110. In this scenario, the stored content 452 corresponds to the three minutes of live content 450 that was missed by the user 140 while the user 140 was away from the first display device 130.

If the length of time satisfies (e.g., is greater than or equal to) the threshold, the processor 112 may provide a summary of the missed content to the user 140 when the user 140 returns to the first display device 130. For example, if the processor 112 determines that the user 140 is away from the first display device 130 for six minutes and the returns to the first display device 130, the processor 112 may provide a summary of the live content 450 missed by the user 140. The summary may include features of the summary 312 described with respect to FIG. 3.

According to one implementation, the processor 112 may set up a profile that includes multiple users. For example, the profile may include the user 140, a spouse of the user 140, and a child of the user 140. If the processor 112 determines that a person associated with the profile has left a vicinity of the first display device 130, the processor 112 may retrieve stored content 452 from the content provider 102 (or from the memory 114) and play the stored content 452 at the first display device 130 to “catch up” the person in the profile that has left the vicinity of the first display device 130. According to one implementation, the user device 112 may be associated with a digital video recorder and playback of the content 150 may be paused upon a determination that the person in the profile has left the vicinity of the first display device 130.

According to another implementation, the processor 112 may set up different profiles for different users. For example, the processor 112 may set up a first profile for the user 140, a second profile for the spouse of the user 140, and a third profile for the child of the user 140. The processor 112 may generate a different summary for each profile. For example, the processor 112 may generate a first summary for the first profile, a second summary for the second profile, and a third summary for the third profile. According to one implementation, the processor 112 may display the content 150 at the first display device 130 and display the content 150 at a remote device (e.g., a mobile device, a television, etc.) associated with a second profile in response to a determination that the person associated with the second profile (e.g., the spouse of the user 140) is not within the vicinity of the first display device 130.

The system 400 of FIG. 4 may enable the user 140 to “catch up” with missed content if the user 140 is engaged with (e.g., interested in) the live content 450 and the user 140 leaves the vicinity of the first display device 130. For example, if the user 140 misses a small portion of the live content 450, the content provider 102 may provide the missed portion as stored content 452 to enable the user 140 to “catch up”. If the user 140 misses a large portion of the live content 450, the processor 112 may generate a summary of the missed portion to catch the user 140 up. Thus, “catch up” content may include a video replay of the content missed by the user 140 and the “summary” may summarize the content missed by the user 140.

FIG. 5 illustrates a method 500 for enhancing a viewing experience based on user engagement. The method 500 may be performed by the user device 110 of FIGS. 1 and 4.

The method 500 includes determining, at a processor, a level of user engagement associated with live content of a particular program displayed at a first display device, at 502. For example, referring to FIG. 4, the sensing circuitry 122 may detect a facial expression of the user 140 while the live content 450 is displayed at the first display device 130. Upon detecting the facial expression of the user 140 using the sensing circuitry 122, the user engagement detector 120 may determine the level of user engagement associated with the live content 450 displayed at the first display device 130. For example, the user engagement detector 120 may include facial detection circuitry to detect the expression of the user 140, and the user engagement detector 120 may determine the intensity level of the expression. As a non-limiting example, the user engagement detector 120 may determine that the user 140 is laughing while the live content 450 is displayed at the first display device 130. In response to the determining that the user 140 is laughing, the user engagement detector 120 may assign a numerical indicator representative of the “intensity level” of the user's 140 laugh. The intensity level of the laugh may be indicative of the level of user engagement. To illustrate, the intensity level may be a numerical value between zero and ten. If the user engagement detector 120 determines that the user 140 has a “small” laugh, the user engagement detector 120 may assign a low intensity level (e.g., an intensity level of zero, one, two, or three) to represent the user's 140 laugh. If the user engagement detector 120 determines that the user 140 has a “big” laugh, the user engagement detector 120 may assign a high intensity level (e.g., an intensity level of seven, eight, nine, or ten) to represent the user's 140 laugh.

The method 500 also includes determining that the level of user engagement satisfies a first threshold, at 504. For example, referring to FIG. 4, the processor 112 may set the laughing threshold to eight (on a scale from zero to ten). The comparison circuitry 124 may compare the level of user engagement to the laughing threshold. For example, the comparison circuitry 124 may compare the intensity level of the user's 140 laugh to the laughing threshold. If the intensity level of the user's 140 laugh is equal to or greater than the laughing threshold, the comparison circuitry 124 may determine that the level of user engagement satisfies the first threshold.

The method 500 also includes determining a period of time that user is not within a particular distance of the first display device, at 506. For example, referring to FIG. 4, the sensing circuitry 122 may determine whether the user 140 is physically located near the first display device 130 (e.g., whether the user 140 is at the first position 142). As long as the user 140 is near the first display device 130, the live content 450 may be displayed at the first display device 130. However, if the user 140 leaves the vicinity of the first display device 130 (e.g., the user 140 goes to the third position 444), the processor 112 may determine the length of time that the user 140 is away from the first display device.

The method 500 also includes displaying a summary of the live content at the first display device if the period of time satisfies a second threshold, at 508. The summary may summarize portions of the live content broadcasted while the user was not within the particular distance of the first display device. For example, referring to FIG. 4, the processor 112 may provide the summary of the missed content to the user 140 when the user 140 returns to the first display device 130. For example, if the processor 112 determines that the user 140 is away from the first display device 130 for a period of time that is longer than the second threshold and the returns to the first display device 130, the processor 112 may provide the summary of the live content 450 missed by the user 140. The summary may include features of the summary 312 described with respect to FIG. 3.

The method 500 also includes displaying stored content at the first display device if the period of time fails to satisfy the second threshold, at 510. The stored content may correspond to portions of the live content broadcasted while the user was not within the particular distance of the first display device. For example, referring to FIG. 4, if the processor 112 determines that the user 140 is not within a threshold distance of the first display device 130 for a period of time that is shorter than the second threshold and then returns to the first display device 130, the processor 112 may generate a request for the stored content 452, and the transceiver 118 may send the request to the content provider 102 via the network 106. To illustrate, the content provider 102 may store the live content 450 in a database as stored content 452. Upon request from the user device 110, the content provider 102 may provide the stored content 452 to user device 110.

The method 500 of FIG. 5 may enable the user 140 to “catch up” with missed content if the user 140 is engaged with (e.g., interested in) the live content 450 and the user 140 leaves the vicinity of the first display device 130. For example, if the user 140 misses a small portion of the live content 450, the content provider 102 may provide the missed portion as stored content 452 to enable the user 140 to “catch up”. If the user 140 misses a large portion of the live content 450, the processor 112 may generate a summary of the missed portion to catch the user 140 up.

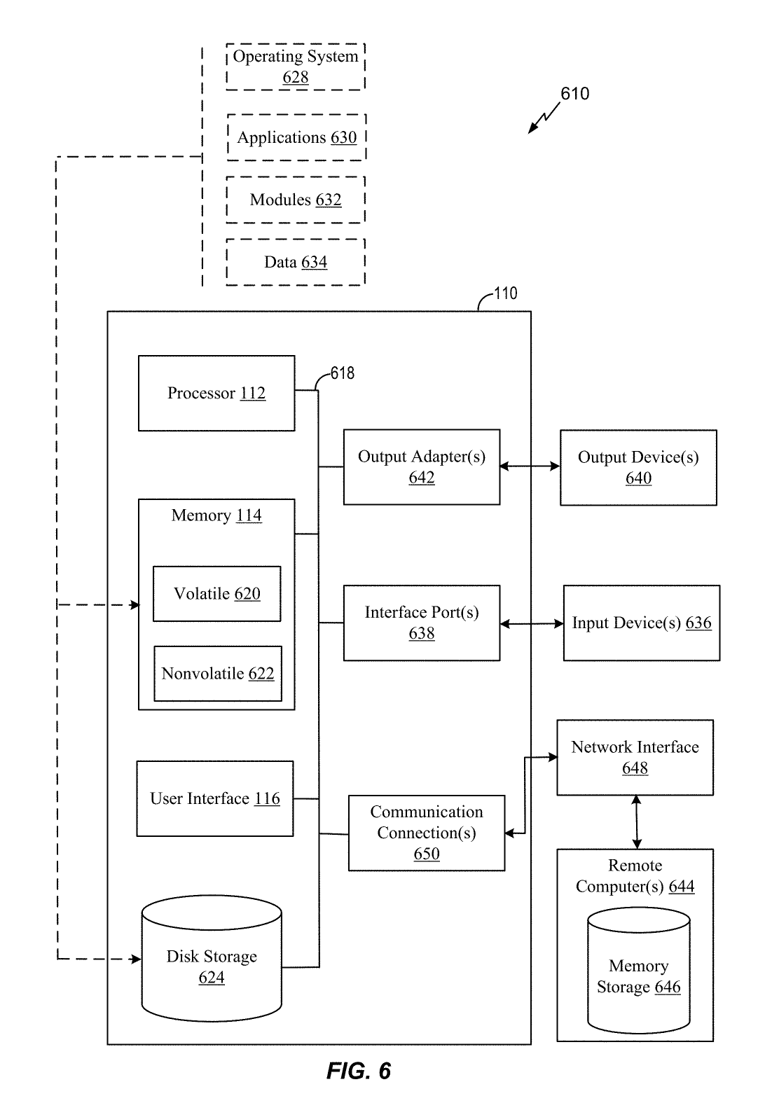

With reference to FIG. 6, an example environment 610 for implementing various aspects of the aforementioned subject matter, including enhancing a viewing experience based on user engagement, includes a user device 110. The user device 110 includes the processor 112, the memory 114, and a system bus 618. The system bus 618 couples system components including, but not limited to, the memory 114 to the processor 112. The processor 112 can be any of various available processors. Dual microprocessors and other multiprocessor architectures as well as a programmable gate array and/or an application-specific integrated circuit (and other devices) also can be employed as the processor 112.

The system bus 618 can be any of several types of bus structure(s) including the memory bus or memory controller, a peripheral bus or external bus, and/or a local bus using any variety of available bus architectures including, but no limited to, 6-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCM-CIA), Small Computer Systems Interface (SCSI), PCI Express (PCIe), and PCI Extended (PCIx).

The memory 114 includes volatile memory 620 and/or nonvolatile memory 622. The basic input/output system (BIOS), including the basic routines to transfer information between elements within the user device 110, such as during start-up, is stored in the nonvolatile memory 622. By way of illustration, and not limitation, the nonvolatile memory 622 can include read only memory (ROM), programmable ROM (PROM), electrically programmable ROM (EPROM), electrically erasable PROM (EEPROM), or flash memory. The volatile memory 620 includes random access memory (RAM), which functions as an external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), memristors, and optical RAM.

The user device 110 also includes removable/non-removable, volatile/non-volatile computer storage media. FIG. 6 illustrates, for example, a disk storage 624. The disk storage 624 includes, but is not limited to, devices like a magnetic disk drive, floppy disk drive, tap drive, Zip drive, flash memory card, secure digital, or memory stick. In addition, the disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive), a digital versatile disk ROM drive (DVD-ROM), a Blue Ray Drive, or an HD-DVD Drive. To facilitate connection of the disk storage devices 624 to the system bus 618, a removable or non-removable interface is typically used such as user interface 116.

It is to be appreciated that FIG. 6 describes software that acts a as an intermediary between users and the basic computer resources described in the suitable operating environment 610. Such software includes an operating system 628. The operation system 628, which can be stored on the disk storage 624, acts to control and allocate resources of the user device 110. System applications 630 take advantage of the management of resources by the operating system 628 through program modules 632 and program data 334 stored either in memory 114 or on disk storage 624. It is to be appreciated that the subject matter herein may be implemented with various operating systems or combinations of operating systems.

A user enters commands or information into the user device 110 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, etc. These and other input devices connect to the processor 112 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port, FireWire port, or other suitable port may be used to provide input to the user device 110, and to output information from the user device 110 to an output device 640. An output adapter 642 is provided to illustrate that there are some output devices 640 like monitors, speakers, and printers, among other output devices 640, which have special adapters. The output adapters 642 include, by way of illustration and not limitation, video and sound cards that provide a means of connections between the output device 640 and the system bus 618. It should be noted that other devices and/or systems of devices provide both input and output capabilities such as remote computer(s) 644.

The user device 110 can operate in a networked environment using logical connections to one or more remote computers, such as remote computer(s) 644. The remote computers(s) 644 can be a personal computer, a server, a router, a network PC, a workstation, a microprocessor based appliance, a peer device or other common network node, etc., and typically includes many or all of the elements described relative to the user device 110. For purposes of brevity, only a memory storage device 646 is illustrated with remote computer(s) 644. Remote computer(s) 644 is logically connected to the user device 110 through a network interface 648 and then physically connected via a communication connection 650. The network interface 648 encompasses communication networks (e.g., wired networks and/or wireless networks) such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5, etc. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside the user device 110, it can also be external to the user device 110. The hardware/software necessary for connection to the network interface 648 includes, for exemplary purposes only, internal and external technologies such as, modems including regular telephone grade modems, cable modems and DSL modems, ISDN adapters, and Ethernet cards.

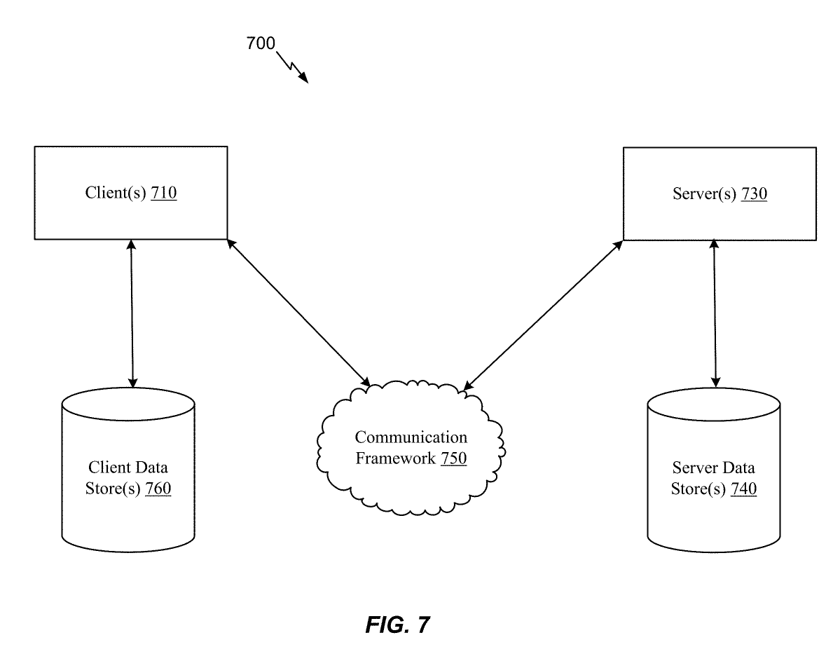

FIG. 7 is a schematic block diagram of a sample-computing system 700 with which the disclosed subject matter can interact. The system 700 includes one or more client(s) 710. The client(s) 710 can be hardware and/or software (e.g., threads, processes, computing devices). The system 700 also includes one or more server(s) 730. The server(s) 730 can also be hardware and/or software (e.g., threads, processes, computing devices). One possible communication between a client 710 and a server 730 can be in the form of a data packet adapted to be transmitted between two or more computer processes. The system 700 includes a communication framework 750 that can be employed to facilitate communications between the client(s) 710 and the server(s) 730. The client(s) 710 are operably connected to one or more client data store(s) 760 that can be employed to store information local to the client(s) 710. Similarly, the server(s) 730 are operably connected to one or more server data store(s) 740 that can be employed to store information local to the servers 730.

In an alternative implementation, dedicated hardware implementations, such as application specific integrated circuits, programmable logic arrays and other hardware devices, may be constructed to implement one or more of the methods described herein. Various implementations may include a variety of electronic and computer systems. One or more implementations described herein may implement functions using two or more specific interconnected hardware modules or devices with related control and data signals that can be communicated between and through the modules, or as portions of an application-specific integrated circuit (ASIC). Accordingly, the present system encompasses software, firmware, and hardware implementations.

In accordance with various implementations of the present disclosure, the methods described herein may be implemented by software programs executable by a computer system, a processor, or a device, which may include forms of instructions embodied as a state machine implemented with logic components in an ASIC or a field programmable gate array (FPGA) device. Further, in an exemplary, non-limiting implementation, implementations may include distributed processing, component/object distributed processing, and parallel processing. Alternatively, virtual computer system processing may be constructed to implement one or more of the methods or functionality described herein. It is further noted that a computing device, such as a processor, a controller, a state machine or other suitable device for executing instructions to perform operations may perform such operations directly or indirectly by way of one or more intermediate devices directed by the computing device.

The illustrations of the implementations described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. Figures are also merely representational and may not be drawn to scale. Accordingly, the disclosure and the figures are to be regarded as illustrative rather than restrictive.

Although specific implementations have been illustrated and described herein, it should be appreciated that any subsequent arrangement designed to achieve the same or similar purpose may be substituted for the specific implementations shown. This disclosure is intended to cover any and all subsequent adaptations or variations of various implementations.

Less than all of the steps or functions described with respect to the exemplary processes or methods can also be performed in one or more of the exemplary implementations. Further, the use of numerical terms to describe a device, component, step or function, such as first, second, third, and so forth, is not intended to describe an order unless expressly stated. The use of the terms first, second, third and so forth, is generally to distinguish between devices, components, steps or functions unless expressly stated otherwise. Additionally, one or more devices or components described with respect to the exemplary implementations can facilitate one or more functions, where the facilitating (e.g., facilitating access or facilitating establishing a connection) can include less than every step needed to perform the function or can include all of the steps needed to perform the function.

In one or more implementations, a processor (which can include a controller or circuit) has been described that performs various functions. It should be understood that the processor can be implemented as multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, an application specific integrated circuit, and/or a programmable gate array (PGA) including a FPGA. In one or more implementations, when a processor executes instructions to perform “operations”, this can include the processor performing the operations directly and/or facilitating, directing, or cooperating with another device or component to perform the operations.

The Abstract is provided with the understanding that it will not be used to interpret or limit the scope or meaning of the claims. In addition, in the foregoing Detailed Description, various features may be grouped together or described in a single implementation for the purpose of streamlining the disclosure. This disclosure is not to be interpreted as reflecting an intention that the claimed implementations require more features than are expressly recited in each claim. Rather, as the following claims reflect, inventive subject matter may be directed to less than all of the features of any of the disclosed implementations. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other implementations, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method comprising:
comparing, at a processor, a the level of user engagement to a threshold, the level of user engagement associated with content displayed at a first display device; and
in response to the level of user engagement satisfies satisfying the threshold:
sending a request for supplemental content associated with the content to a server;
receiving the supplemental content; and
initiating, by the processor, display of the supplemental content at a second display device based on a location of a user relative to the first display device.

2. The method of claim 1, wherein the supplemental content includes an advertisement, and wherein initiating display of the supplemental content at the second display device includes selecting the second display device in response to a distance between the user and the first display device exceeding a threshold distance.

3. The method of claim 1, further comprising determining the level of user engagement is-based on data indicating a pulse of the user, an expression of the user, or a combination thereof, the data received from a biometric sensor, a camera, or a combination thereof

4. The method of claim 1, further comprising:
in response to determining that the user is located more than a threshold distance from the first display device for a period of time having a duration that exceeds a duration threshold, generating a summary of a portion of the content that corresponds to the period of time; and
displaying the summary at the first display device in response to detecting that the user is located less than the threshold distance from the first display device.

5. The method of claim 4, wherein the summary includes a condensed version of video the portion of the content.

6. The method of claim 4, wherein the summary includes a textual description of the portion of the content.

7. The method of claim 1, further comprising providing suggested content to the first display device or the second display device in response to the level of user engagement satisfying the threshold.

8. The method of claim 1, further comprising, in response to determining that the user is located less than a threshold distance from the first display device after the user has been located more than the threshold distance from the first display device for a period of time, displaying a portion of the content at the first display device, the portion corresponding to the period of time.

9. An apparatus comprising:
a processor; and
a memory storing instructions executable by the processor to perform operations comprising:
comparing a level of user engagement to a threshold, the level of user engagement associated with content displayed at a first display device; and
in response to the level of user engagement satisfies satisfying the threshold:
sending a request for supplemental content associated with the content to a server;
receiving the supplemental content; and
initiating display of the supplemental content at a second display device based on a location of a user relative to the first display device.

10. The apparatus of claim 9, wherein the content includes live content.

11. The apparatus of claim 9, wherein the request for the supplemental content indicates that a subject of the content is of interest to the user.

12. The apparatus of claim 9, further comprising a sensor device including a camera, an infrared sensor, or a combination thereof, wherein the operations further include determining the location of the user based on data generated by the sensor device.

13. The apparatus of claim 9, operations further include:
comparing a second level of user engagement to a second threshold, the second level of user engagement associated with a second content displayed at the first display device; and
in response to the second level of user engagement not satisfying the second threshold, displaying default supplemental content at the first display device or the second display device.

14. The apparatus of claim 10, wherein the operations further comprise in response to determining that the user is located less than a threshold distance from the first display device after the user has been located more than the threshold distance from the first display device for a period of time, displaying a portion of the content at the first display device, the portion corresponding to the period of time.

15. The apparatus of claim 14, wherein the operations further include storing the portion in the memory while the user is located more than the threshold distance from the first display device during the period of time.

16. The apparatus of claim 9, wherein the operations further comprise changing the content in response to the level of user engagement failing to satisfy the threshold.

17. A computer-readable storage device comprising instructions that, when executed by a processor, cause the processor to perform operations comprising:
comparing a level of user engagement to a threshold, the level of user engagement associated with content displayed at a first display device; and
in response to the level of user engagement satisfies satisfying the threshold:
sending a request for supplemental content associated with the content to a server;
receiving the supplemental content; and
initiating display of the supplemental content at a second display device based on a location of a user relative to the first display device.

18. The computer-readable storage device of claim 17, wherein the first display device includes a television, a mobile phone, a tablet, or a computer.

19. The computer-readable storage device of claim 17, wherein the operations further comprise providing the content to a remote device in response to the level of user engagement satisfying the threshold, and wherein the remote device includes a digital video recorder.

20. (canceled)

21. The apparatus of claim 12, further comprising a camera, wherein the operations further include:
setting the threshold to a first level in response to data generated by the camera indicating that the user smiled; and
setting the threshold to a second level in response to the data generated by the camera indicating that the user frowned.
